(19) United States
(12) Patent Application Publication
(10) Pub. No.: US 2015/0135462 A1
(43) Pub. Date: May 21, 2015

(54) VEHICLE WINDOW WIPER SYSTEM PROVIDED WITH A HEATING INDICATOR

(71) Applicant: Valeo Systèmes d'Essuyage, Le Mesnil Saint Denis (FR)

(72) Inventors: Gérald Caillot, Cernay La Ville (FR); Vincent Izabel, Chilly Mazarin (FR); Jean-Michel Jarasson, Le Mesnil Saint Denis (FR)

(21) Appl. No.: 14/547,295

(22) Filed: Nov. 19, 2014

(30) Foreign Application Priority Data
Nov. 19, 2013 (FR) 1361362

(51) Int. Cl. B60S 1/38; B60S 1/52

(52) U.S. Cl. CPC B60S 1/3805; B60S 1/524; B60S 1/3879; B60S 2001/3844
USPC 15/250.04; 15/250.05

(57) ABSTRACT

A vehicle window wiper system including at least one windscreen wiper driven in movement by an arm that is articulated to the wiper by at least one connector/adapter assembly, is disclosed. The wiper system is provided with a heating device. The heating system includes at least one heating indicator indicating that at least one element of said wiper system is at a temperature higher than a predefined threshold value.

The invention primarily concerns a vehicle window wiper system provided with a heating indicator.

The invention also relates to a motor vehicle equipped with at least one such system.

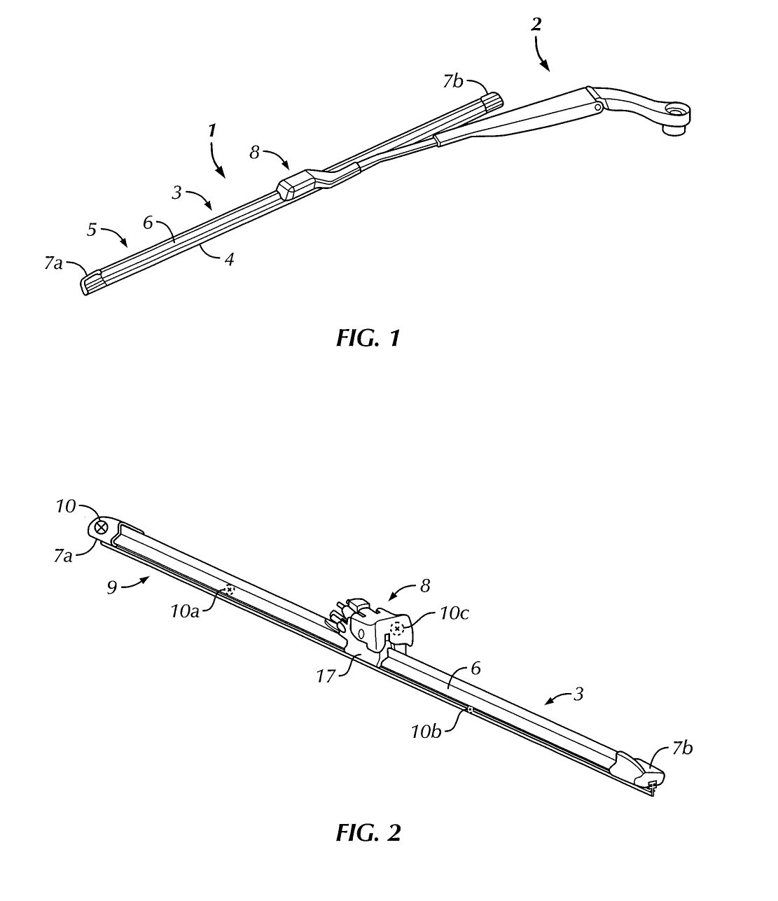

Referring to FIG. 1, in a known manner, a vehicle window wiper system 1 includes an arm 2 intended to effect an angular to-and-fro movement driving a wiper 3 rubbing against the window to be cleaned of the vehicle.

To this end, the wiper 3 includes an elastic material wiper blade 4, a support structure 5 retaining the blade 4 and a profile 6 usually referred to as a deflector surmounting the support structure 5 over the whole of its length. At each end of the wiper there is an assembly end-fitting 7a, 7b adapted to hold together the wiper blade 4, the support structure 5 and the profile 6.

The arm 2 ends at its external end at a yoke fixed, notably crimped, to the arm 2. Alternatively, this yoke may equally well be formed at the end of the arm by deforming the latter and constitute a unitary assembly with the arm. The function of the latter is to support the wiper 3 via an adapter 8 and a connector 17.

The connector 17 is crimped to the wiper 3 and transmits forces to the wiper and the adapter 8 is an intermediate part ensuring compatibility between different yoke shapes and the same wiper. The adapter 8 and the connector 17 are articulated to rotate relative to each other about an axis perpendicular to the wiper 3.

For some types of wiper system, windscreen-washing liquid is fed from a reservoir by a pump to one or more liquid spray manifolds distributed along the wiper 3 but not visible in this figure. Each manifold then extends along a longitudinal axis defining the length of the wiper. Windscreen-washing liquid tube(s), not shown, run along the arm 2 to the connector 17 and supply each manifold with liquid. The liquid spray manifold(s) may be inside the profile 6, for example.

There also exist liquid sprayer systems disposed on the arms 2 of the wiper systems.

Low temperatures in winter compromise correct functioning of wiper systems whether the wiper system is equipped with a liquid sprayer device or not.

In the case of a wiper system provided with a liquid sprayer device, the operation of the system may be impeded when the temperature of the windscreen-washing liquid is low, for example less than 5° C. The liquid sprayer manifold(s) disposed on the wiper may notably be partly or totally frozen up and the general flexibility of the wiper may be reduced. In a known manner, the windscreen-washing liquid may be heated by a heating device using electrical heating conductors embedded in the mass of the windscreen-washing liquid supply tube(s) or by an appropriate heating device disposed on the support structure 5 of the wiper.

Likewise, regardless of the type of wiper system, low temperatures lead to a reduction of wiping quality because of the loss of flexibility of the rubber constituting the elastic material of the wiper blade 4 of the wiper 3.

It is also found that an accumulation of snow or ice on the wiper may prevent it from operating correctly, notably by impeding correct return of the wiper blade between to-and-fro movements of the arm.

Such effects can be corrected by an appropriate heating device disposed on the support structure 5 of the wiper.

Whether the situation is that of a windscreen-washing liquid heater device disposed on the upstream side of the wiper 3 or heated wipers, heating is controlled automatically in accordance with predefined temperature criteria.

As a result of this the user is not advised when the wipers and/or the windscreen-washing liquid are being heated.

In this context, the present invention is aimed at a wiper system enabling the user to be advised that the device for heating the wipers and/or the windscreen-washing liquid is operating.

To this end, the vehicle window wiper system includes at least one windscreen wiper driven in movement by an arm that is articulated to said wiper by at least one connector/adapter assembly, which system is provided with a heating device, characterized in that it includes at least one heating indicator indicating that at least one element of said wiper system is at a temperature higher than a predefined threshold value.

The wiper system of the invention may also have the following optional features separately or in all technically possible combinations:
the wiper includes at least one support structure retaining a wiper blade and a profile on top of the support structure over all of its length, said wiper further including at its opposite ends two assembly end-fittings, and the heating indicator is located on the wiper blade and/or on the profile and/or on an assembly end-fitting and/or on the connector and/or on the adapter;
the wiper includes at least one support structure retaining a wiper blade and a profile on top of the support structure over all of its length, the support structure of the wiper includes two stiffener vertebrae retained in longitudinal grooves of the wiper blade and at least one holding element having an arm locally capping the profile, the two ends of said holding element each engaging over each vertebra of the wiper, and the heating indicator is located on said holding element;
the wiper system includes a liquid sprayer system integrated into the wiper including at least one manifold extending along a longitudinal axis defining the length of the wiper and at least one liquid feed tube running along the arm to the connector and supplying said manifold with liquid;
the wiper system includes a liquid sprayer system disposed on the arm;
the heating device is adapted to heat the liquid and is disposed on the support structure of the wiper and/or on the feed tube supplying said manifold with liquid;
the heating indicator is disposed on the arm;
the heating indicator includes a thermochromic material;
the thermochromic material takes the form of an informational message, and the thermochromic material is translucent in the absence of any heating of an element of the wiper system or is the same colour as the part supporting it, and the thermochromic material is coloured when said element is hot;
the heating indicator consists of a first layer forming an informational message applied to an element of the wiper system, said first layer being covered by a thermochromic material that is coloured in the absence of any heating of said element so as to mask the informational message thereon and translucent when said element is hot so as to reveal the informational message;
the thermochromic material of the heating indicator includes thermochromic pigments, colouring agents or crystals.

The invention relates finally to a motor vehicle equipped with at least one wiper system as defined above.

Other features and advantages of the invention will emerge clearly from the description given hereinafter by way of nonlimiting illustration and with reference to the appended figures, in which:

FIG. 1, already described, is a diagrammatic representation in perspective of a prior art wiper system,

FIG. 2 is a diagrammatic representation in perspective of a wiper of the wiper system of the invention in accordance with a first type of embodiment as seen from the passenger compartment side of the vehicle,

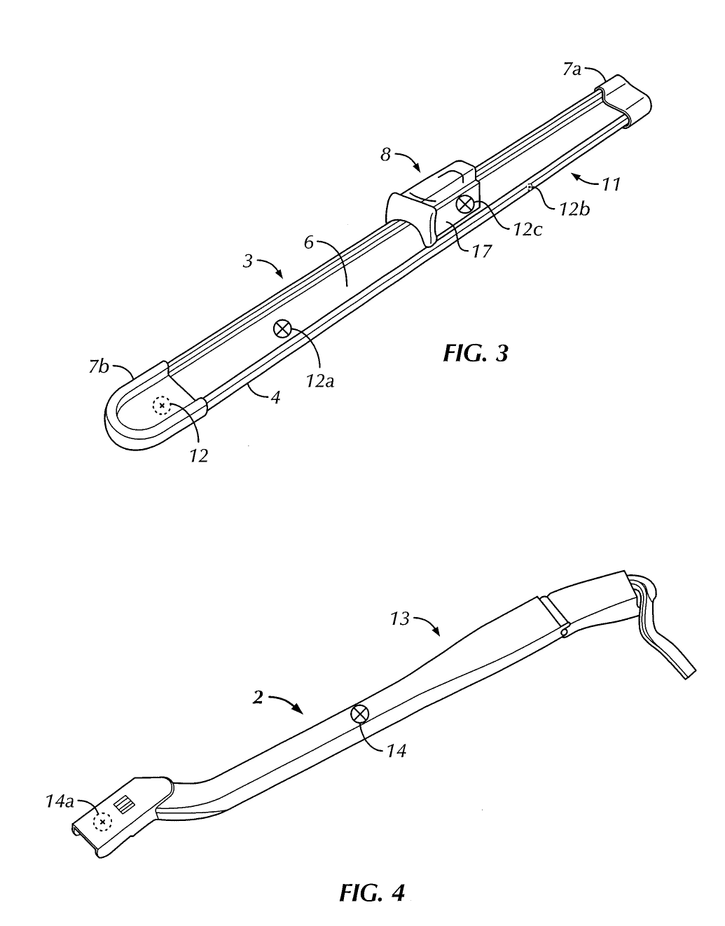

FIG. 3 is a diagrammatic representation in perspective of a wiper of the wiper system of the invention in accordance with a second type of embodiment as seen from the outside of the vehicle,

FIG. 4 is a diagrammatic representation in perspective of the upper face of the arm of the wiper system of the invention in accordance with a third type of embodiment,

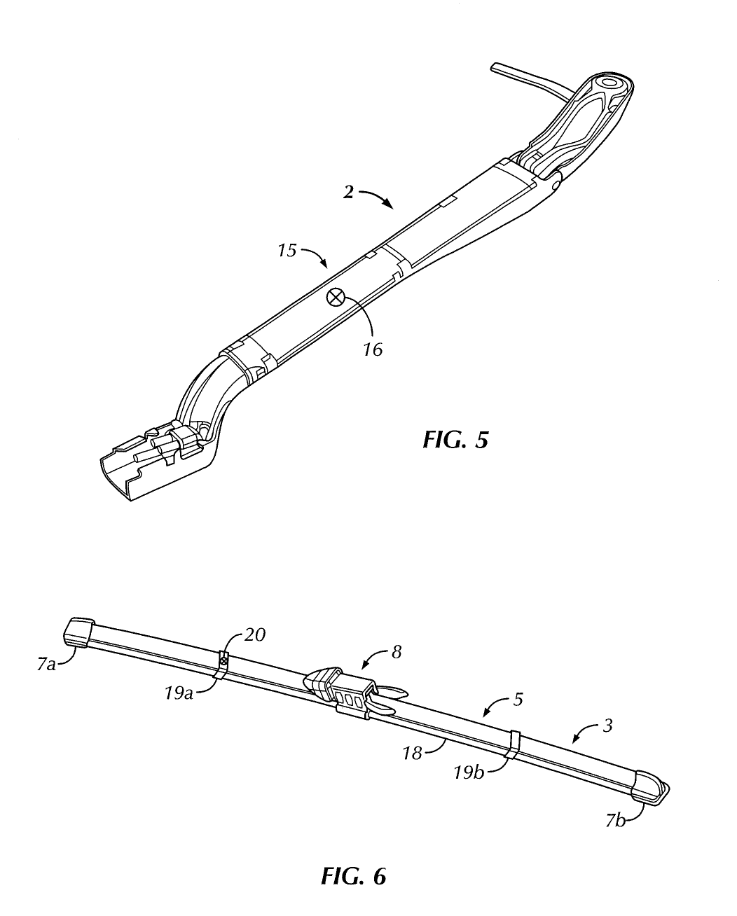

FIG. 5 is a diagrammatic representation in perspective of the lower face of the arm of the wiper system of the invention in accordance with a fourth type of embodiment, and

FIG. 6 is a diagrammatic representation in perspective of a wiper of the wiper system of the invention in accordance with a fifth type of embodiment.

The invention consists in providing a heating indicator placed in an area of the wiper system liable to be heated either by a wiper heating device if the wiper system is provided with such a device or by a device for heating the windscreen-washing liquid if the wiper system is provided with that device.

The heating indicator includes a thermochromic material that reacts to heat by changing colour. There may be cited in this regard thermochromic colouring agents, pigments and crystals.

Referring to FIG. 2, when the wiper system 1 includes a device for heating the wiper 3, a heating indicator may be provided located on the face 9 of the wiper 3 that faces toward the passenger compartment of the vehicle. The heating indicator 10 may then be on one of the two assembly end-fittings 7a, 7b; the heating indicator 10a may equally well be positioned on the deflector 6; the heating indicator 10b may further be on the wiper blade 4 or the heating indicator 10c may be on the adapter 8 or the connector 17. In the context of the invention, a plurality of these heating indicators 10, 10a, 10b, 10c may equally well be provided on this face 9 of the wiper 3. The heating indicator 10, 10a, 10b, 10c then has the advantage of being visible from the passenger compartment of the vehicle.

Referring to FIG. 3, the heating indicator may be located on the face 11 of the wiper 3 opposite the face 9, that is to say the face that is not visible to the occupants of the vehicle but is visible from the outside of the vehicle. As before, the heating indicator 12 may then be on one of the two assembly end-fittings 7a, 7b; the heating indicator 12a may equally well be positioned on the deflector 6; the heating indicator 12b may further be on the wiper blade 4 or the heating indicator 12c may be on the adapter 8 or the connector 17. In the context of the invention, a plurality of these heating indicators 12, 12a, 12b, 12c may equally well be provided on this face 11 of the wiper 3. The heating indicator 12, 12a, 12b, 12c is then visible from the outside of the vehicle.

Referring to FIG. 6, the support structure 5 of the wiper 3 may notably comprise two stiffener vertebrae 18 inserted in longitudinal grooves in the wiper blade 4. In the situation represented, the profile 6 is made in one piece with the wiper blade 4. Retaining elements 19a, 19b disposed half-way between the assembly end-fittings 7a, 7b and the connector/adapter assembly are attached to the wiper 3. In the example represented there are two of these retaining elements 19a, 19b, each element being disposed between one of the assembly end-fittings 7a, 7b and the connector/adapter assembly. Each retaining element 19a, 19b has an arm locally capping the profile 6 and two ends each engaging over each vertebra 18 of the wiper. In this embodiment, the heating indicator 20 may then be located on one of the retaining elements 19a, 19b or on both the retaining elements 19a, 19b or on any other element of the wiper that is suitable (see above).

The wiper 3 may equally well include one or more heating indicators located on its face 11 visible from the outside of the vehicle and one or more heating indicators located on its face 9 visible from the passenger compartment side.

Referring to FIG. 4, the wiper system 1 may equally well include a device for heating the windscreen-washing liquid. The windscreen-washing liquid feed tube(s) described above and not visible in this figure convey(s) the heated windscreen-washing liquid along the arm 2 to the connector 17.

The liquid is heated either directly in the feed tube(s) by heating means disposed in the material constituting said tubes or by a heating system disposed on the upstream side of the feed tube(s).

The arm 2 and the connector 17 are therefore heated by the circulation of the hot windscreen-washing liquid.

In accordance with the invention, the heating indicator may then be located on the face 13 of the arm 2 that is on the side opposite the bonnet of the vehicle, that is to say on the upper face of the arm 2. The heating indicator 14 may to this end be positioned on the arm 2 or the heating indicator 14a may be positioned on the yoke positioned at the end of the arm. The heating indicator 14, 14a is then visible from the outside of the vehicle.

Referring to FIG. 5, the heating indicator 16 may equally well be located on the face 15 of the arm 2 of the wiper system facing the bonnet of the vehicle, that is to say the lower face of the arm 2. The heating indicator 16 may then be positioned directly on the feed tube(s) running along the arm 2 or on the exterior face of a concealer retaining the feed tube(s) in the arm 2. In a variant that is not shown, the wiper system may include a windscreen-washing liquid sprayer system including nozzles positioned on the arm 2. In such a case, the heating indicator may be positioned in the vicinity of the nozzles for spraying hot water.

The heating indicator 10, 10a, 10b, 10c; 12, 12a, 12b, 12c; 14, 14a; 16; 20 communicates information to the user to the effect that the wiper 3 or the arm 2 of the wiper system is hot and consequently also information to the effect that the device for heating the wiper 3 or the device for heating the windscreen washer liquid is in operation.

Now, these devices for heating the wiper 3 or the windscreen-washing liquid are controlled automatically to operate when a parameter crosses a threshold value, for example if the outside temperature falls below a threshold temperature. Consequently, the change of colour of the heating indicator indicates that the environmental conditions are wintry and call for particular care in driving.

The change of colour of the heating indicator also indicates that manipulation of the wiper or the arm should be avoided because of its high temperature.

In accordance with the invention, the heating indicator 10, 10a, 10b, 10c; 12, 12a, 12b, 12c; 14, 14a; 16; 20 may assume two different configurations, these configurations merely representing nonlimiting embodiments.

Firstly, there may be provided a heating indicator 10, 10a, 10b, 10c; 12, 12a, 12b, 12c; 14, 14a; 16; 20 consisting of a layer of thermochromic material that changes from translucent to coloured when the wiper 3 or the arm 2 is hot. The layer of thermochromic material may take the form of an informational message alerting the user, if the heating indicator becomes coloured, either to wintry conditions or to the high temperature of the wiper or arm. Alternatively, the thermochromic material may be the same colour as the part that supports it and change colour when the wiper 3 or the arm 2 is hot.

There may equally well be provided a heating indicator 10, 10a, 10b, 10c; 12, 12a, 12b, 12c; 14, 14a; 16; 20 consisting of an informational first layer of non-thermochromic material, covered by a layer of thermochromic material that is coloured, notably the same colour as the part supporting it and that becomes translucent when hot. When the wiper 3 or the arm 2 is hot, the layer of material becoming translucent allows the informational first layer to be seen.

The thermochromic materials are chosen from known thermochromic materials depending on whether these materials are required to be coloured when hot or colourless when hot.

Moreover, depending on the material on which the heating indicator is placed, the thermochromic material will be chosen to react at a given heating temperature. By way of nonlimiting illustration, the thermochromic material could react at a temperature of 60 to 65° C., notably if the heating indicator is used to warn the user of the risk of burns in the event of contact with the wiper and/or the arm of the wiper system.

Thus, in accordance with the invention, the change of colour of a thermochromic material placed on an area of the wiper system that is heated if the external temperature is low makes it possible to alert the driver to hazardous environmental conditions in order that they adapt their driving for better safety and can also make it possible to advise them to avoid manipulating this area of the wiper system.

The invention applies equally well to a wiper system with no liquid sprayer manifold. In this case, the heating device is disposed essentially on the wiper and the aim is to ensure correct operation of the wiper in wintry conditions and to maintain the elastic properties of the wiper blade.

1. A vehicle window wiper system comprising:
at least one windscreen wiper driven in movement by an arm that is articulated to said wiper by at least one connector/adapter assembly, wherein the wiper system is provided with a heating device; and
at least one heating indicator indicating that at least one element of said wiper system is at a temperature higher than a predefined threshold value.

2. The wiper system according to claim 1, wherein the wiper includes at least one support structure retaining a wiper blade and a profile on top of the support structure over all of its length, said wiper further including at its opposite ends two assembly end-fittings, and in that the heating indicator is located on the wiper blade and/or on the profile and/or on an assembly end-fitting and/or on the connector and/or on the adapter.

3. The wiper system according to claim 1, wherein the wiper includes at least one support structure retaining a wiper blade and a profile on top of the support structure over the whole of its length, the support structure of the wiper including two stiffener vertebrae retained in longitudinal grooves of the wiper blade and at least one holding element having an arm locally capping the profile, the two ends of said holding element each engaging over each vertebra of the wiper, and in that the heating indicator is located on said holding element.

4. The wiper system according to claim 1, further comprising a liquid sprayer system integrated into the wiper including at least one manifold extending along a longitudinal axis defining the length of the wiper and at least one liquid feed tube running along the arm to the connector and supplying said manifold with liquid.

5. The wiper system according to claim 1, further comprising a liquid sprayer system disposed on the arm.

6. The wiper system according to claim 4, wherein the heating device is adapted to heat the liquid and is disposed on the support structure of the wiper and/or on the feed tube supplying said manifold with liquid.

7. The wiper system according to claim 4, wherein the heating indicator is disposed on the arm.

8. The wiper system according to claim 1, wherein the heating indicator includes a thermochromic material.

9. The wiper system according to claim 8, wherein the thermochromic material takes the form of an informational message and in that the thermochromic material is translucent in the absence of any heating of an element of the wiper system or is the same colour as the part supporting it, and wherein the thermochromic material is coloured when said element is hot.

10. The wiper system according to claim 8, wherein the heating indicator consists of a first layer forming an informational message applied to an element of the wiper system, said first layer being covered by a thermochromic material that is coloured in the absence of any heating of said element so as to mask the informational message thereon and translucent when said element is hot so as to reveal the informational message.

11. The wiper system according to claim 8, wherein the thermochromic material of the heating indicator includes one selection from the group consisting of thermochromic pigments, colouring agents and crystals.

12. A motor vehicle equipped with at least one wiper system according to claim 1.
